(19) United States
(12) Patent Application Publication
(10) Pub. No.: US 2013/0336706 A1
(43) Pub. Date: Dec. 19, 2013

(54) CONNECTOR FITTING JIG AND LOW INSERTION FORCE CONNECTOR

(71) Applicant: Osamu Oshita, Aichi (JP)

(72) Inventor: Osamu Oshita, Aichi (JP)

(21) Appl. No.: 14/002,704

(22) PCT Filed: Mar. 1, 2012
(86) PCT No.: PCT/JP2012/055238

§ 371 Date: Aug. 30, 2013

(30) Foreign Application Priority Data
Mar. 1, 2011 (JP) 2011-044363

(51) Int. Cl. H01R 13/631; H01R 43/26

(52) U.S. Cl. CPC H01R 13/631; H01R 43/26
USPC 403/11; 29/700

(57) ABSTRACT

A connector fitting jig for attaching and detaching a first housing and a second housing to and from each other by a low insertion and separation force, includes a jig body, a first support shaft that includes a base end rotatably supported by a first rotation support shaft provided on the jig body and a catching portion formed on a free end thereof, the catching portion being catchable in a pulling-up direction to a caught portion of a first engagement portion or a second engagement portion respectively formed in the first housing and the second housing, and a second support shaft that includes a base end rotatably supported by a second rotation support shaft provided on the jig body and a pressing portion formed on a free end thereof.

### TECHNICAL FIELD

The present invention relates a connector fitting jig and a low insertion force connector, in which fitting of the connector can be performed by a low insertion force.

### BACKGROUND ART

As a low insertion force connector, in which fitting of the connector can be performed by a low insertion force, a low insertion force connector disclosed in PTL 1 is known. As shown in FIG. 9, a low insertion force connector 501 includes a male connector 503, a female connector 505, and a rotary shaft 507. The male connector 503 has a pair of left and right flexible arms 513 protruding toward a connector fitting direction from an outlet of a shaft hole 509 provided to extend through a housing, and a pair of front and rear dislodging prevention protrusions 515 provided in a direction perpendicular to the flexible arms 513. The flexible aims 513 have, on the middle parts thereof, narrowed portions 533 formed to define an opposing width narrower than an inner diameter of the shaft hole 509, and distal ends thereof are respectively provided with an inward catching claw 511. The female connector 505 is successively provided with temporary engaging holes 517 and main engaging holes 519 for the catching claws 511 of the flexible arms 513 in the connector fitting direction, and also provided with pin-shaped screw engaging protrusions 521 on an extension line of the shaft hole 509. The rotary shaft 507 has screw thread portions 523 provided on a distal end of a small diameter portion 525 thereof for the pin-shaped screw engaging protrusions 521. Also, the rotary shaft 507 has an annular portion 527 and an annular groove 529 formed continuously to the small diameter portion 525. The annular portion 527 has inserting grooves 531 for the dislodging prevention protrusions 515. The annular groove 529 is communicated with the inserting grooves 531 and allows the dislodging prevention protrusions 515 and the narrowed portions 533 to be successively engaged thereto.

The low insertion force connector 501 as described is configured such that, after the male connector 503 and the female connector 505 are temporarily engaged to each other, a shaft distal end of the rotary shaft 507 is inserted through the shaft hole 509 of the male connector 503 and the dislodging prevention protrusions 515 are inserted through the inserting grooves 531. Then, the narrowed portions 533 of the flexible arms 513 are engaged into the annular groove 529. The catching claws 511 of the flexible arms 513 are engaged into the temporary engaging holes 507 of the female connector 505, thereby performing positioning of the connectors to each other.

Subsequently, the shaft distal end of the rotary shaft 507 is pressed in so that the narrowed portions 533 of the flexible arms 513 are outwardly pushed and spread out, thereby releasing the temporary engagement of the caching claws 511. The dislodging prevention protrusions 515 of the male connector 503 are engaged into the annular grooves 529 of the rotary shaft 507 to fix the small diameter portion 525 in an axial direction thereof. The pin-shaped screw engaging protrusions 521 of the female connector 505 are positioned on the small diameter portion 525 of the rotary shaft 507.

Also, a handle 535 is used to rotate the rotary shaft 507 by a half turn, and thus the pin-shaped screw engaging protrusions 521 are pulled up along the screw thread portions 523. The pin-shaped screw engaging protrusions 521 are positioned in an inserting notch of the screw thread portions 523 rotated by a half turn. The dislodging prevention protrusions 515 of the male connector 503 are positioned in the inserting grooves 531 of the annular portion 527, and the flexible arms 513 of the male connector 503 are positioned such that the caching claws 511 oppose the main engaging holes 519 of the female connector 505 in a spread-out state.

Finally, the small diameter portion 525 of the rotary shaft 507 is removed from the male connector 503 and the female connector 505. As a result, the catching claws 511 are engaged into the main engaging holes 519 of the female connector 505, thereby locking the male connector 503 and the female connector 505 to each other.

### CITATION LIST

### Patent Literature

PTL1: Japanese Patent No. 2613998

### SUMMARY OF INVENTION

### Technical Problem

However, in the low insertion force connector 501 as described above, the male connector 503 has to be provided with the flexible arms 513, the caching claws 511, the dislodging prevention protrusions 515 and the narrowed portions 533, and also the female connector 505 has to be provided with the temporary engaging holes 517, the main engaging holes 519 and the pin-shaped screw engaging protrusions 521. As a result, there are many special-shaped portions, which are difficult to be integrally formed with each other, and thus the housing structure is complicated, thereby causing an increase in size thereof. Further, because a lead angle of the screw thread portions 523 adapted to be engaged with the pin-shaped screw engaging protrusions 521 cannot be reduced in a limited space, it is impossible for an actuation force to be sufficiently small.

The present invention has been made keeping in mind the above problems, and an object of the invention is to provide a connector fitting jig and a low insertion force connector, in which the connector can be fitted or separated by a small actuation force, without providing a complex housing structure.

### Solution to Problem

The above object of the present invention is achieved by the following configurations (1) to (7).

(1) A connector fitting jig for attaching and detaching a first housing and a second housing to and from each other by a low insertion and separation force, including: a jig body; a first support shaft including a base end rotatably supported by a first rotation support shaft provided on the jig body and a caching portion formed on a free end thereof, the catching portion being catchable in a pulling-up direction to a caught portion of a first engagement portion or a second engagement portion respectively formed in the first housing and the second housing; and a second support shaft including a base end rotatably supported by a second rotation support shaft provided on the jig body and a pressing portion formed on a free end thereof, the pressing portion being contactable to a pressed portion of the second engagement portion or the first engagement portion respectively formed in the first housing and the second housing; wherein the first housing and the second housing are moved relative to each other in a connector fitting direction, by pushing down the second support shaft using as a fulcrum the catching portion of the first support shaft.

(2) The connector fitting jig according to (1), wherein the jig body includes a handle portion which extends to an opposing side of the first rotation support shaft with respect to the second rotation support shaft. (3) The connector fitting jig according to (2), wherein the catching portion includes a catching protrusion provided to protrude from a lateral surface of the first support shaft facing the second support shaft.

(4) A low insertion force connector having a first housing and a second housing adapted to be attached to and detached from each other by a low insertion and separation force, including: a through-shaft protruding on a fitting surface side of the first housing and passing through a shaft hole provided to extend through the second housing in a connector fitting direction; a caught portion formed in a first engagement portion provided on a through-distal end portion of the through-shaft; and a pressed portion formed in a second engagement portion provided on an outer surface of the second housing, the shaft hole being opened in the outer surface; wherein the second housing is moved in the connector fitting direction by pushing down the pressed portion of the second engagement portion using as a fulcrum the caught portion of the first engagement portion.

(5) The low insertion force connector according to (4), wherein the second housing is moved in a connector separating direction by pulling up a caught portion formed in the second engagement portion using as a fulcrum a pressed portion formed in the first engagement portion.

(6) The low insertion force connector according to (4), wherein the caught portion of the first engagement portion is formed in a lateral surface of the first engagement portion opposite to the second engagement portion.

(7) The low insertion force connector according to (5), wherein the caught portion of the second engagement portion is formed in a lateral surface of the second engagement portion opposite to the first engagement portion.

According to the connector fitting jig of the above configuration (1), by actuating the jig body, the second support shaft can be pushed down by a lever action using as a fulcrum the caching portion of the first support shaft. Therefore, because the first housing and the second housing can be moved relative to each other in the connector fitting direction, the first housing and the second housing can be fitted to or separated from each other by a small actuation force.

According to the connector fitting jig of the above configuration (2), by pushing down a distal end of the handle portion, the second support shaft can be easily pushed down by a small actuation force.

According to the connector fitting jig of the above configuration (3), the catching portion of the first support shaft and the pressing portion of the second support shaft can be provided adjacent to each other, and thus a rotational moment of the housings caused with respect to the fitting direction when the first housing and the second housing are fitted to and separated from each other can be suppressed, thereby preventing scraping.

According to the low insertion force connector of the above configuration (4), if the connector fitting jig, for example, of the above configuration (1) is used so that the caught portion of the first engagement portion provided on the through-shaft of the first housing serves as a fulcrum and thus the pressed portion of the second engagement portion provided on the second housing is pushed down, the second housing can be pushed down relative to the first housing, thereby fitting the first housing and the second housing to each other.

According to the low insertion force connector of the above configuration (5), if the connector fitting jig, for example, of the above configuration (1) is used so that the pressed portion of the first engagement portion provided on the through-shaft of the first housing serves as a fulcrum and thus the caught portion of the second engagement portion provided on the second housing is pulled up, the second housing can be pulled up relative to the first housing, thereby separating the first housing and the second housing from each other.

According to the low insertion force connector of the above configuration (6), the caught portion of the first engagement portion is formed in the lateral surface of the first engagement portion opposite to the second engagement portion and thus is arranged adjacent to the pressed portion of the second engagement portion, so that a rotational moment of the housings caused with respect to the fitting direction when the first housing and the second housing are fitted to each other can be suppressed, thereby preventing scraping. Also, a distance between the pressed portion of the second engagement portion, which is a fulcrum, and the caught potion of the first engagement portion, which is an acting point, can be shortened, thereby reducing an actuation force.

According to the low insertion force connector of the above configuration (7), the caught portion of the second engagement portion is formed in the lateral surface of the second engagement portion opposite to the first engagement portion and thus is arranged adjacent to the pressed portion of the first engagement portion, so that a rotational moment of the housings caused with respect to the separating direction when the first housing and the second housing are separated from each other can be suppressed, thereby preventing scraping. Also, a distance between the pressed portion of the first engagement portion, which is a fulcrum, and the caught potion of the second engagement portion, which is an acting point, can be shortened, thereby reducing an actuation force.

In the foregoing, the present invention has been briefly described. Also, details of the present invention will be further apparent, when modes (hereinafter, referred to as “embodiments”) for embodying the invention as described below are thoroughly read with reference to the accompanying drawings.

### BRIEF DESCRIPTION OF DRAWINGS

FIG. 1 is a partially cut-away side view of a connector fitting jig according to an embodiment of the present invention.

FIG. 2 is an exploded perspective view of a low insertion force connector according to an embodiment of the present invention.

FIG. 3 is a perspective view of the low insertion force connector before fitting for explaining a fitting operation of the connector using the connector fitting jig shown in FIG. 1.

FIG. 4 is a partially cut-away side view of the connector fitting jig and the low insertion force connector shown in FIG. 3.

FIG. 5 is an enlarged view of a main part of the low insertion force connector shown in FIG. 4.

FIG. 6 is a perspective view of the low insertion force connector after fitting for explaining a fitting operation of the connector using the connector fitting jig shown in FIG. 1.

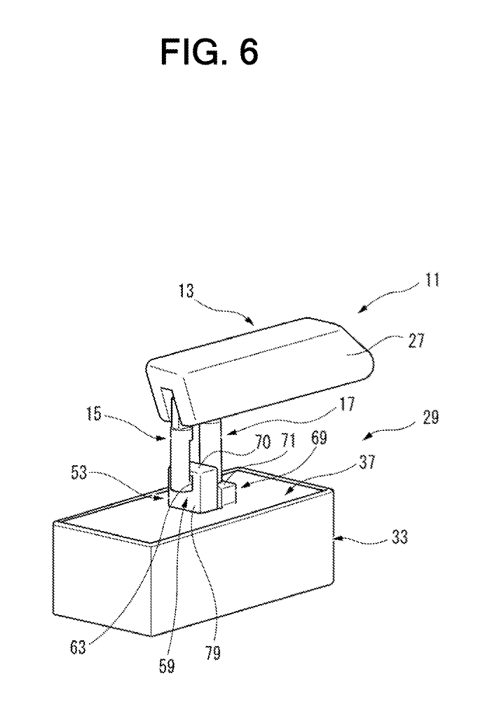

FIG. 7 is a partially cut-away side view of the connector fitting jig and the low insertion force connector shown in FIG. 6.

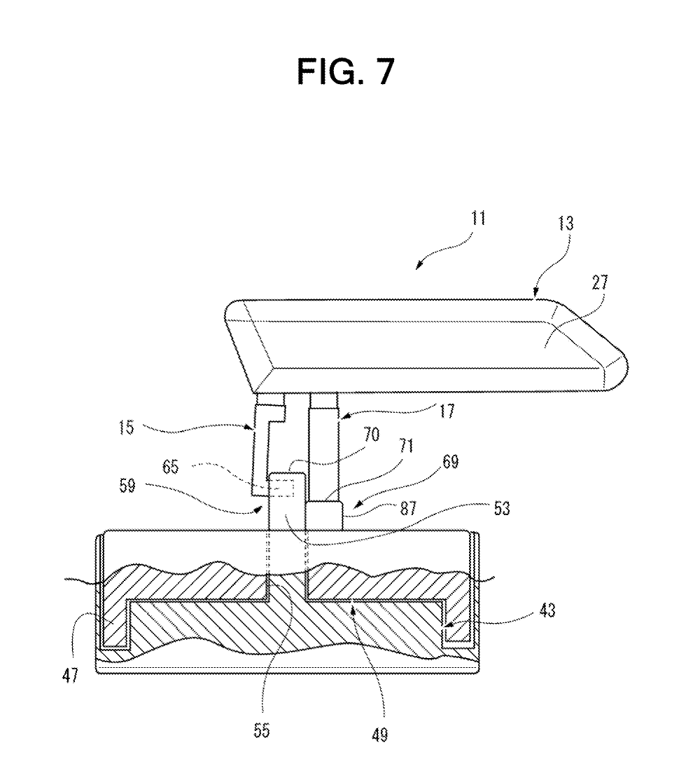

FIG. 8 is a partially cut-away side view of the connector fitting jig and the low insertion force connector for explaining a separation operation of the connector using the connector fitting jig shown in FIG. 1.

FIG. 9 is an exploded longitudinal sectional view of a low insertion force connector according to the related art.

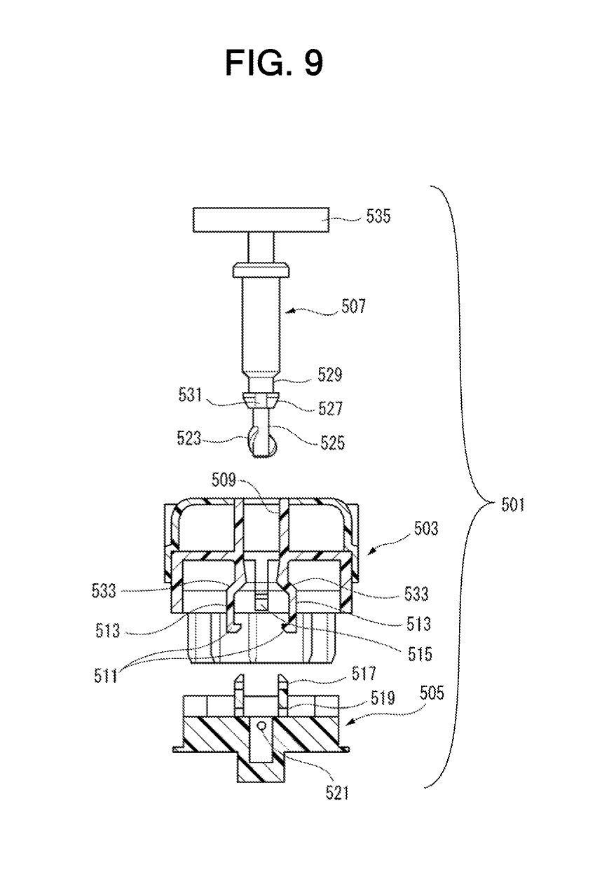

### DESCRIPTION OF EMBODIMENTS

An embodiment according to the present invention will be now described in detail with reference to the accompanying drawings.

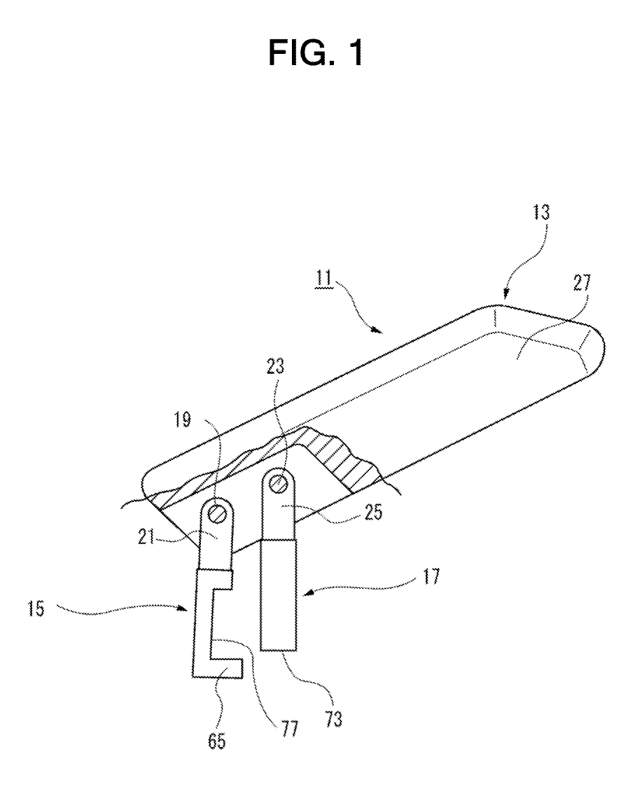

As shown in FIG. 1, a connector fitting jig 11 according to the present embodiment includes a jig body 13 formed in a rod shape, a first support shaft 15 having a generally half-cylindrical shape, and a second support shaft 17 having a generally cylindrical shape.

The jig body 13 is provided, on one end side thereof (a left end side in FIG. 1), with a first rotation support shaft 19, and a base end 21 of the first support shaft 15 is rotatably supported by the first rotation support shaft 19. The first support shaft 15 is provided, on a free end thereof, with a L-shaped catching protrusion 65, which is a catching portion catchable in a pulling-up direction to a first caught portion (a caught portion) 63 of a first engagement portion 59 formed in a male connector housing 33 as described below.

Also, a second rotation support shaft 23 is provided on a portion of the jig body 13 which is located more toward the other end side thereof than the first rotation support shaft 19, and a base end 25 of the second support shaft 17 is rotatably supported by the second rotation support shaft 23. The second rotation support shaft 23 is provided, on a free end thereof, with a pressing portion 73 contactable to a second pressed portion (a pressed portion) 71 of a second engagement portion 69 formed in a female connector housing 37 as described below.

In addition, the jig body 13 has a handle portion 27 provided to extend to the opposing side of the first rotation support shaft 19 (the other end side of the jig body 13) with respect to the second rotation support shaft 23.

As a result, the connector fitting jig 11 according to the present embodiment can easily push down the second support shaft 17 by a small actuation force, by pushing down a distal end (a right side in FIG. 1) of the handle portion 27 using as a fulcrum the catching protrusion 65 of the first support 15.

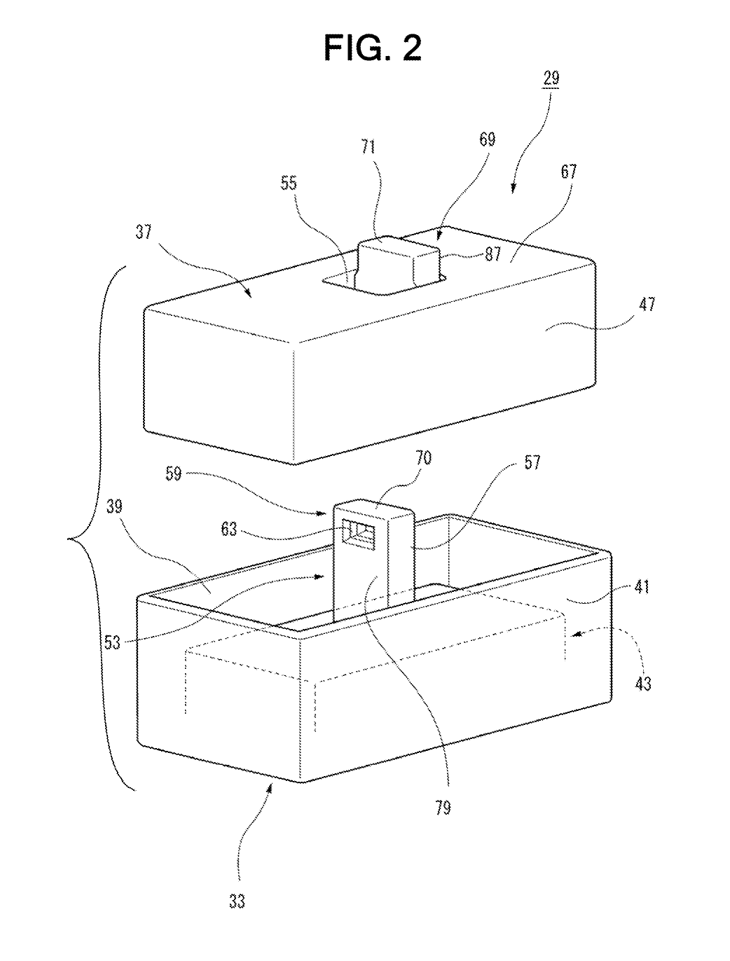

As shown in FIG. 2, a low insertion force connector 29 according to the present embodiment includes a male connector housing 33 as a first housing, and a female connector housing 37 as a second housing.

The male connector housing 33 has a rectangular hood portion 41 opened on an upper surface thereof to provide a fitting open 39, and a male connector portion 43 having a shape substantially similar to the hood portion 41 is provided to protrude on the inside of the hood portion 41. A plurality of connection terminals, not shown, is housed in the interior of the male connector portion 43.

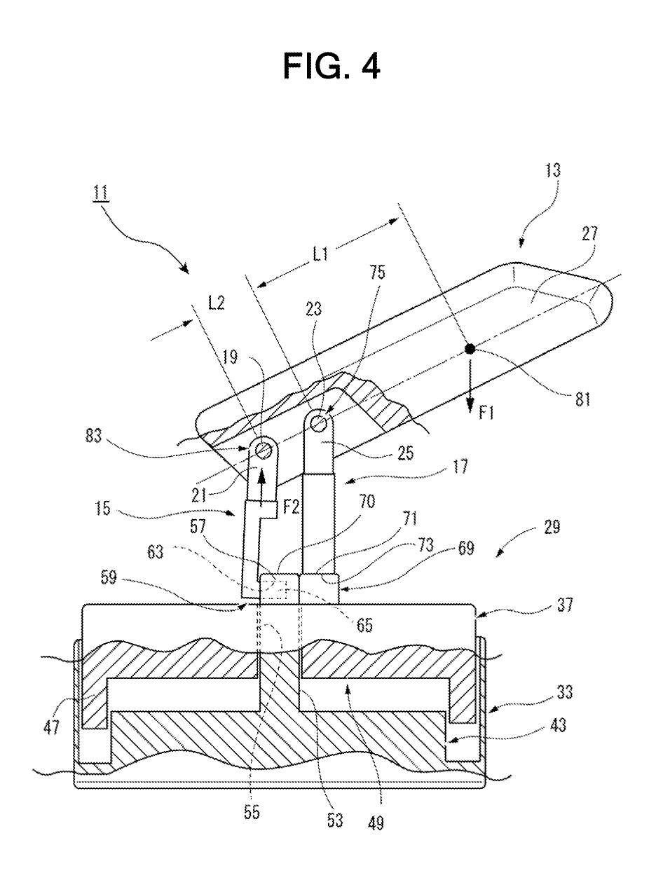

The female connector housing 37 is fitted by inserting a housing peripheral wall 47 on a lower side thereof into the hood portion 41 of the male connector housing 33. On a lower surface of the housing peripheral wall 47, a female connector portion 49 (see FIG. 4) adapted to receive the male connector portion 43 is provided. A plurality of connection terminals, not shown, is housed in the interior of the female connector portion 49. The male connector housing 33 and the female connector housing 37 are configured such that, when the housing peripheral wall 47 of the female connector housing 37 enters the hood portion 41 of the male connector housing 33, the male connector portion 43 is fitted in the female connector portion 49, thereby connecting connection terminals to each other.

The male connector housing 33 according to the present embodiment is provided with a through-shaft 53 protruded toward a fitting direction (an upward direction in FIG. 2) at the substantially center of the male connector portion 43, which corresponds to a fitting surface side. Although the through-shaft 53 according to the present embodiment is formed in a rectangular prism shape, the present invention is not limited to this configuration, and accordingly, the through-shaft 53 may have a half-cylindrical shape or a polygonal prism shape, such as a hexagonal prism or an octagonal prism. When the male connector housing 33 is fitted to the female connector housing 37, the through-shaft 53 is passed through a shaft hole 55 provided to extend through the female connector housing 37 in a connecter fitting direction. The through-shaft 53 and the shaft hole 55 have cross-sectional shapes corresponding to each other to be engageable with each other.

A through-distal end portion 57 of the through-shaft 53 is provided with the first engagement portion 59 adapted to be engaged with the first support shaft 15 or the second support shaft 17 of the connector fitting jig 11. The first engagement portion 59 has the first caught portion 63 allowing the catching protrusion 65 of the first support shaft 15 to be caught thereto in the pulling-up direction, and a first pressed portion (a pressed portion) 70 allowing the pressing portion 73 of the second support shaft 17 to be contacted thereto. The first caught portion 63 is a recess opened in a lateral surface of the first engagement portion 59 so that the L-shaped catching protrusion 65 formed on the first support shaft 15 can be caught thereto in the pulling-up direction.

The second engagement portion 69 is provided to protrude on an outer surface 67 of the female connector housing 37 adjacent to the shaft hole 55 extending therethrough. Although the second engagement portion 69 is formed in a rectangular prism shape, the present invention is not limited to this configuration, and accordingly, the second engagement portion 69 may have a half-cylindrical shape or a polygonal prism shape, such as a hexagonal prism or an octagonal prism.

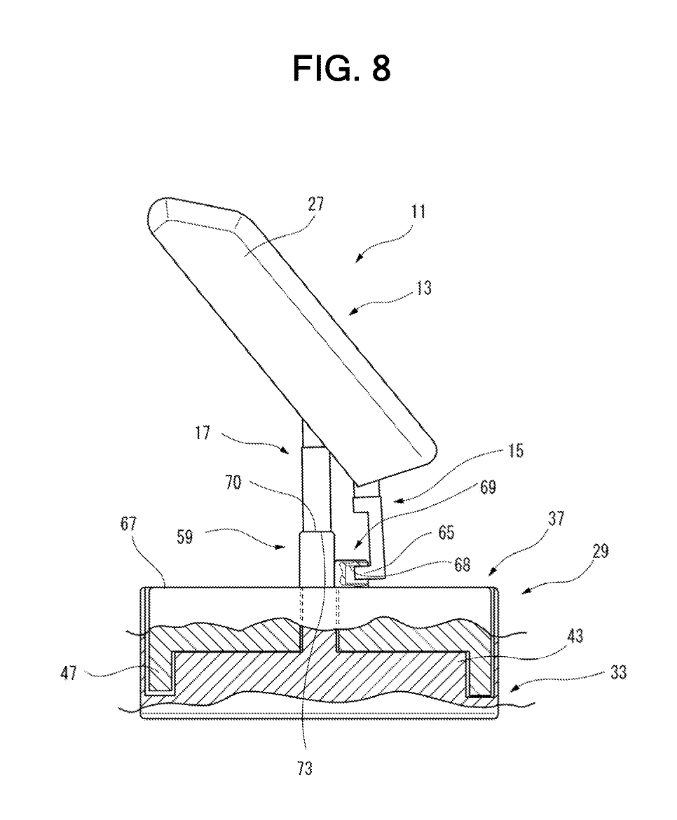

The second engagement portion 69 is adapted to be engaged with the second support shaft 17 or the first support shaft 15 of the connector fitting jig 11, and has the second pressed portion 71 allowing the pressing portion 73 of the second support shaft 17 to be contacted thereto, and a second caught portion (a caught portion) 68 allowing the caching protrusion 65 of the first supporting shaft 15 to be caught thereto in the pulling-up direction (see FIG. 8).

In other words, the caching protrusion 65 of the first support shaft 15 can be caught in the pulling-up direction to the second caught portion 68, which has a shape of a recess opened in a lateral surface of the second engagement portion 69.

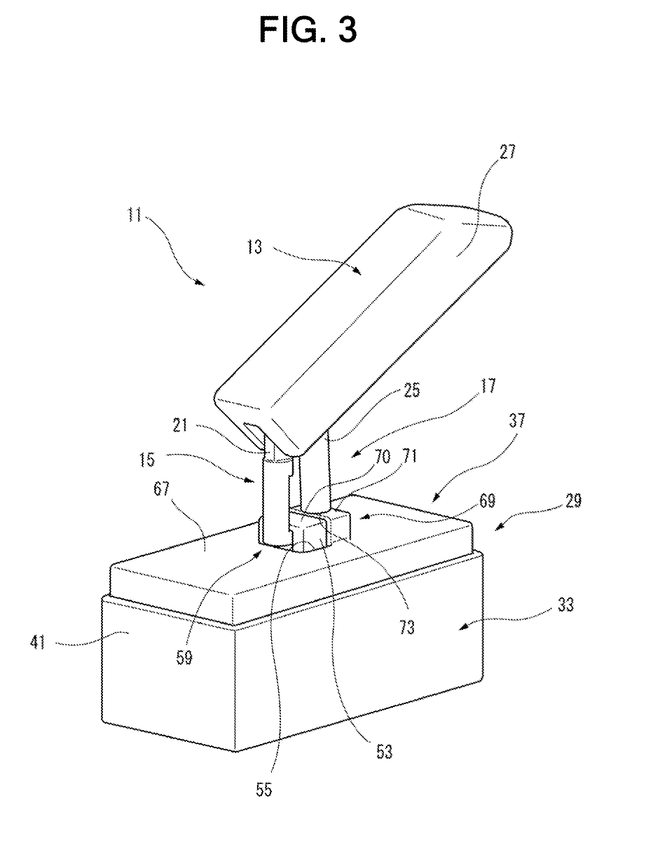

As shown in FIGS. 3 and 4, the low insertion force connector 29 is configured such that, in a step before fitting, the through-shaft 53 is inserted through the shaft hole 55 and thus is protruded from the outer surface 67 of the female connector housing 37 in a state where the first engagement portion 59 and the second engagement portion 69 are arranged side by side. The connector fitting jig 11 moves the male connector housing 33 and the female connector housing 37 in the connector fitting direction by pushing down the second support shaft 17 using as a fulcrum the catching protrusion 65 of the first support shaft 15 in such a state.

Therefore, the connector fitting jig 11 is configured such that the catching protrusion 65 of the first support shaft 15 is caught to the first caught portion 63 of the first engagement portion 59 in the pulling-up direction. In this case, the catching protrusion 65 is provided to protrude, on the free end of the first support shaft, from a lateral surface 77 of the first support shaft facing the second support shaft. Meanwhile, the first caught portion 63 is recessedly provided in the lateral surface 79 of the first engagement portion opposite to the second engagement portion 69, and the second caught portion 68 is recessedly provided in the lateral surface 87 of the second engagement portion opposite to the first engagement portion 59.

Namely, the first engagement portion 59 and the second engagement portion 69 are provided adjacent to each other. By providing the first engagement portion 59 and the second engagement portion 69 adjacent to each other, a rotational moment caused with respect to a fitting direction when the male connector housing 33 and the female connector housing 37 are fitted to or separated from each other can be suppressed, thereby preventing scraping.

Next, operations of the connector fitting jig 11 and the low insertion force connector 29 having the foregoing configurations will be described.

To fit the male connector housing 33 and the female connector housing 37 to each other using the connector fitting jig 11, as shown in FIG. 4, the through-shaft 53 provided to protrude on the male connector housing 33 is firstly passed through the shaft hole 55 of the female connector hosing 37. In this state, the housing peripheral wall 47 of the female connector housing 37 enters the hood portion 41 of the male connector housing 33, thereby obtaining a middle fitting state. In the middle fitting state, the through-shaft 53 protrudes from the outer surface 67 of the female connector housing so that the through-distal end portion 57 of the through-shaft 53 has the substantially same height as that of the second engagement portion 69. Because the through-distal end portion 57 of the through-shaft 53 is provided with the first engagement portion 59, the first engagement portion 59 and the second engagement portion 69 are arranged adjacent to each other while protruding at the substantially same height.

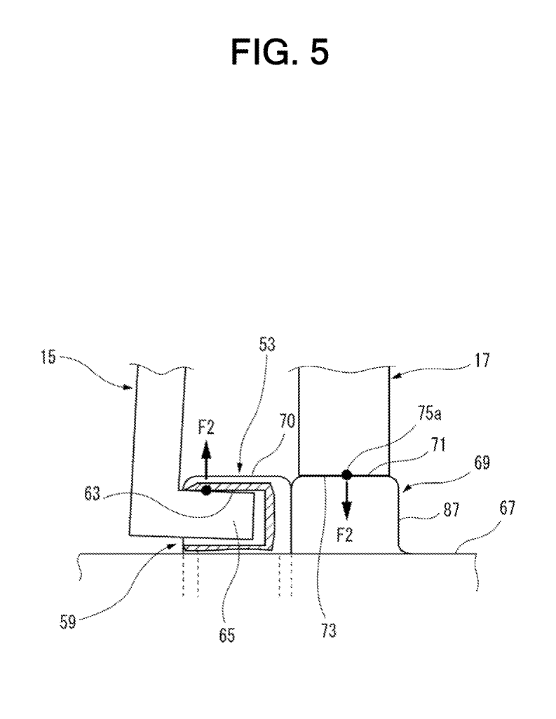

Thus, as shown in FIG. 5, the connector fitting jig 11 is adapted such that the catching protrusion 65 of the first support shaft 15 is caught to the first caught portion 63 of the first engagement portion 59, and the pressing portion 73 of the second support shaft 17 is contacted to the second pressed portion 71 of the second engagement portion 69 from the upper side thereof.

In addition, when the handle portion 27 of the jig body 13 is pivoted downward and thus the second pressed portion 71 of the second engagement portion 69 is pushed down using as a fulcrum the first caught portion 63 of the first engagement portion 59, a force F2 is exerted on the first engagement portion 59 and the second engagement portion 69 in the opposite direction. Therefore, the female connector housing 37 is moved relative to the male connector housing 33 in the connector fitting direction.

In this time, the connector fitting jig 11 attached to the low insertion force connector 29 allows the male connector housing 33 and the female connector housing 37 to be easily fitted to each other according to a lever principle.

Specifically, as shown in FIG. 4, when the second rotation support shaft 23 is used as a fulcrum 75, a distance L1 between the fulcrum 75 and a force point 81 of the handle portion 27 is set to be greater than a distance L2 between the fulcrum 75 and the first rotation support shaft 19, which is an acting point 83 (L1>L2). In this case, if a force exerted on the force point 81 is F1 and a force resulted at the acting point 83 is F2, the following equation is obtained from the lever principle: L1·F1=L2·F2. As a result, because L1>L2, F1<F2. However, for simplicity, the equation expresses when forces exerted on the force point 81 and the acting point 83 are parallel to each other.

In this way, the low insertion force connector 29 is adapted such that the second pressed portion 71 of the second engagement portion 69 is pushed down by the connector fitting jig 11 using as a fulcrum the first caught portion 63 of the first engagement portion 59, thereby fitting the male connector housing 33 and the female connector housing 37 to each other.

Further, as described above, the first caught portion 63 of the first engagement portion 59 is arranged adjacent to the second pressed portion 71 of the second engagement portion 69, so that a rotational moment caused with respect to the fitting direction when the male connector housing 33 and the female connector housing 37 are fitted to each other can be suppressed, thereby preventing scraping. Also, a distance between the second pressed portion 71 and the first caught portion 63 is shortened, thereby reducing an actuation force on the handle portion 27.

In this way, according to the connector fitting jig 11 and the low insertion force connector 29 of the present embodiment, the male connector housing 33 and the female connector housing 37 can be fitted to each other by a small actuation force, by pivoting downward the handle portion 27 of the jig body 13.

Then, when the male connector housing 33 and the female connector housing 37 fitted to each other are separated from each other using the connector fitting jig 11, as shown in FIG. 8, the catching protrusion 65 of the first support shaft 15 of the connector fitting jig 11 is caught to the second caught portion 68 of the second engagement portion 69, and the pressing portion 73 of the second support shaft 17 is contacted to the first pressed portion 70 of the first engagement portion 59 from the upper side thereof.

Also, if the handle portion 27 of the jig body 13 is pivoted downward, the first pressed portion 70 of the first engagement portion 59 serves as a fulcrum, and thus the second engagement portion 69 is pulled up. Then, the female connector housing 37 is pulled up from the male connector housing 33 according to the lever principle, and as a result, the male connector housing 33 and the female connector housing 37 are separated from each other. Thus, the male connector housing 33 and the female connector housing 37 can be separated from each other by a small actuation force.

In this way, according to the connector fitting jig 11 and the low insertion force connector 29 of the present embodiment, the male connector housing 33 and the female connector housing 37 can be separated from each other by a small actuation force, by pivoting downward the handle portion 27 of the jig body 13.

Therefore, according to the connector fitting jig 11 and the low insertion force connector 29 of the present embodiment, the male connector housing 33 and the female connector housing 37 can be fitted to or separated from each other by a small actuation force, without providing the male connector housing 33 and the female connector housing 37 with a complex structure.

Meanwhile, components, such as the jig body, the first and second rotation support shafts, the handle portion, the catching portion, the pressing portion, the first and second housings, the through-shaft, the shaft hole, the first and second engagement portions, the caught portions and the pressed portions, according to the connector fitting jig and the low insertion force connector of the present invention are not limited to the configurations of the foregoing embodiment, but can employ various configurations based on the spirit of the invention. In addition, material, shape, dimension, number, installation position and the like of each of the components of the foregoing embodiment are not limited but arbitrary as long as the present invention can be achieved.

For example, although, in the foregoing embodiment, the male connector housing 33 is described as the first housing and the female connector housing 37 is described as the second housing, the female connector housing may be the first housing and the male connector housing may be the second housing.

Also, although, in the foregoing embodiment, the first support shaft 15 is rotatably supported on the one end side of the jig body 13 and the second support shaft 17 is rotatably supported on the other end side of the jig body 13, the second support shaft 17 may be rotatably supported on the one end side of the jig body 13 and the first support shaft 15 may be rotatably supported on the other end side of the jig body 13. In this case, by pivoting upward the handle portion 27 of the jig body 13, the male connector housing 33 and the female connector housing 37 can be moved relative to each other in the fitting direction by a small actuation force.

This application is based on Japanese Patent Application No. 2011-044363 filed on Mar. 1, 2011, the entire contents of which are incorporated herein by reference.

### INDUSTRIAL APPLICABILITY

According to the connector fitting jig and the low insertion force connector of the present invention, the connector can be fitted or separated by a small actuation force, without providing a complex housing structure.

### REFERENCE SIGNS LIST

11 Connector fitting jig
13 Jig body
15 First support shaft
17 Second support shaft
19 First rotation support shaft
21 Base end
23 Second rotation support shaft
25 Base end
27 Handle portion
29 Low insertion force connector
33 Male connector housing (First housing)
37 Female connector housing (Second housing)
53 Through-shaft
55 Shaft hole
57 Through-distal end portion
59 First engagement portion
63 First caught portion (Caught portion)
65 Catching protrusion (Catching portion)
67 Outer surface
68 Second caught portion (Caught portion)
69 Second engagement portion
70 First pressed portion (Pressed portion)
71 Second pressed portion (Pressed portion)
73 Pressing portion
77 Lateral surface of the first support shaft
79 Lateral surface of the first engagement portion
80 Lateral surface of the second engagement portion

1. A connector fitting jig for attaching and detaching a first housing and a second housing to and from each other by a low insertion and separation force, comprising:
a jig body;
a first support shaft that includes a base end rotatably supported by a first rotation support shaft provided on the jig body and a catching portion formed on a free end thereof, the catching portion being catchable in a pulling-up direction to a caught portion of a first engagement portion or a second engagement portion respectively formed in the first housing and the second housing; and
a second support shaft that includes a base end rotatably supported by a second rotation support shaft provided on the jig body and a pressing portion formed on a free end thereof, the pressing portion being contactable to a pressed portion of the second engagement portion or the first engagement portion respectively formed in the first housing and the second housing;
wherein the first housing and the second housing are moved relative to each other in a connector fitting direction, by pushing down the second support shaft using as a fulcrum the catching portion of the first support shaft.

2. The connector fitting jig according to claim 1, wherein the jig body includes a handle portion which extends to an opposing side of the first rotation shaft with respect to the second rotation support shaft.

3. A low insertion force connector having a first housing and a second housing thereof adapted to be attached to and detached from each other by a low insertion and separation force, comprising:
a through-shaft the protrudes on a fitting surface side of the first housing and passes through a shaft hole provided to extend through the second housing in a connector fitting direction;
a caught portion that is formed in a first engagement portion provided on a through-distal end portion of the through-shaft; and
a pressed portion that is formed in a second engagement portion provided on an outer surface of the second housing, the shaft hole being opened in the outer surface;
wherein the second housing is moved in the connector fitting direction by pushing down the pressed portion of the second engagement portion using as a fulcrum the caught portion of the first engagement portion.

4. The low insertion force connector according to claim 3, wherein the second housing is moved in a connector separating direction by pulling up a caught portion formed in the second engagement portion using as a fulcrum a pressed portion formed in the first engagement portion.
